(19) United States
(12) Patent Application Publication
(10) Pub. No.: US 2004/0145560 A1
(43) Pub. Date: Jul. 29, 2004

(54) Backlight driving apparatus for LCD

(75) Inventor: Jae-Hyun Kim, Gyeonggi-do (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 10/739,308

(22) Filed: Dec. 19, 2003

(30) Foreign Application Priority Data
Jan. 24, 2003 (KR) 2003-4777

(51) Int. Cl. G09G 3/36

(52) U.S. Cl. 345/102

(57) ABSTRACT

A backlight driving apparatus is provided which effectively suppresses noise by synchronizing a frequency of a pulse width modulation (PWM) signal to drive a backlight which projects rays on a liquid crystal panel with a scan frequency of the liquid crystal panel. The backlight driving apparatus is used for an liquid crystal display having a liquid crystal panel to display a picture signal and a backlight to project rays on the liquid crystal panel, and includes an NTSC/PAL detector, which detects a vertical frequency of the picture signal, and an inverter, which receives a predetermined constant voltage and generates the PWM signal to drive the backlight. The inverter controls the frequency of the PWM signal based on a decision result of the NTSC/PAL detector.

### CROSS-REFERENCE TO RELATED APPLICATIONS

This application claims the priority of Korean Patent Application No. 2003-4777 filed on Jan. 24, 2003, in the Korean Intellectual Property Office, the disclosure of which is incorporated herein by reference.

### BACKGROUND OF THE INVENTION

1. Field of the Invention

The present invention relates to a liquid crystal device (LCD), and more particularly, to a backlight driving apparatus which effectively suppresses noise by synchronizing a frequency of a pulse width modulation (PWM) signal to drive a backlight, which projects rays on a liquid crystal panel, with a scan frequency of the liquid crystal panel.

2. Description of the Related Art

In recent years, LCDs have been broadly used in display devices or monitors for portable computers and camcorders. The LCDs employ thin film devices, for example, thin film transistors (TFTs).

An LCD comprises a liquid crystal panel which operates as an optical shutter, a driving circuit unit which provides a control signal and data so as to display a picture signal on the liquid crystal panel, a backlight which provides a light source, and a backlight driving apparatus which controls the backlight.

The liquid crystal panel includes cells comprised of pixels, the cells being arranged in an array shape. Further, the cells are each driven in horizontal and vertical directions in order. For example, in a case where a picture signal having a size of 720×480 is displayed, one frame comprises 720 pixels in the horizontal direction and 480 lines in the vertical direction, and the lines are each driven in order by a time-division method.

The backlight driving apparatus receives a predetermined constant voltage, converts the predetermined constant voltage into a PWM signal having a predetermined frequency, and supplies the PWM signal to the backlight. To perform these operations, the backlight driving apparatus includes an inverter and a transducer.

In the LCD, if a frequency of the PWM signal applied to the backlight differs from a scan frequency of a picture signal displayed via a thin film device, noise moves on the screen like that of a wave pattern.

Also, in an LCD supporting various video standards, for example, National Television System Committee (NTSC) and Phase Alternating Line (PAL), because vertical and horizontal frequencies of NTSC picture signals differ from those of PAL picture signals, noise may occur when the backlight driving frequency is fixed to one of the standards.

FIG. 1 is an exploded perspective view showing an example of a liquid crystal device (LCD) disclosed in Korean Patent Laid-open Publication No. 2001-40109, dated May 15, 2001. Referring to FIG. 1, the LCD 100 comprises a casing 102, a liquid crystal panel 104, and a backlight 106 with a wave guard 106a and a cathode-ray tube 106b. The casing 102 accommodates and protects the liquid crystal panel 104 and the backlight 106. The liquid crystal panel 104 displays a picture corresponding to a picture signal. The backlight 104 to project rays on the liquid crystal panel 104 is installed under the liquid crystal panel 104. The LCD 100 receives picture signals from a video signal output apparatus, such as a computer, a camcorder, a television, or an optical disc drive.

A picture signal displayed on the liquid crystal panel 104 operates as a shutter to project or to not project rays generated in the backlight 106. Thus, when a frequency of a picture signal displayed on the liquid crystal panel 104 differs from a frequency of a PWM signal driving the backlight 106, noise, such as waves or flickers, may occur on the liquid crystal panel 104.

FIG. 2 is a block diagram of a conventional LCD. Referring to FIG. 2, a picture signal, generated in a video signal generating apparatus, is scaled using a scaler 202 to be suitable for a size of a liquid crystal panel 104 and is supplied to a timing controller 204. The timing controller 204 generates a variety of control signals and data and supplies the control signals and data to a liquid crystal panel 104 so as to display picture signals on the liquid crystal panel 104. The liquid crystal panel 104 displays picture signals according to the control signals and data supplied from the timing controller 204. A backlight 106 is installed under the liquid crystal panel 104.

Further, an inverter 206 converts applied constant voltages from a power supply (not shown) into pulse width modulation (PWM) signals and pulse frequency modulation (PFM) signals, each of which has a predetermined frequency, and supplies the converted PWM and PFM signals to a transducer 208. The transducer 208 converts a low PWM signal, supplied from the inverter 206, into a high signal so as to drive the backlight 106 and supplies the converted signal to the backlight 106. Further, the PWM signal is in a frequency band of 40 KHz to 80 KHz, and a brightness of the backlight 106 is controlled by the pulse width of the PWM signal.

In the conventional backlight driving apparatus, a frequency of a PWM signal output from the inverter 206 is set for a picture signal to one video standard. Thus, if a picture signal in another video standard is displayed, the frequency of the PWM signal differs from a scan frequency of the picture signal in the other video standard, thus generating noise such as waves.

For example, in a case where a picture signal having a size of 720×480 is displayed in a NTSC standard, an NTSC picture signal has a scan frequency of 60 Hz×480 Hz and where the picture signal having the size of 720×480 is displayed in the PAL standard, a PAL picture signal has a scan frequency of 50Hz×480 Hz. If a frequency of a PWM signal to drive the backlight 106 is in NTSC standard, the frequency of the PWM signal differs from the scan frequency of the PAL picture signal, thus generating noise. Further, if the frequency of the PWM signal to drive the backlight 106 is in the PAL standard, the frequency of the PWM signal differs from the scan frequency of the NTSC picture signal, thus generating noise.

### SUMMARY OF THE INVENTION

The present invention provides a backlight driving apparatus with a simple construction, the backlight driving apparatus being capable of suppressing noise in a liquid crystal device (LCD).

In accordance with an aspect, a backlight driving apparatus is provided for an LCD including a liquid crystal panel displaying picture signals and a backlight projecting rays on the liquid crystal panel. The backlight driving apparatus comprises an NTSC/PAL detector, which detects a vertical frequency of a picture signal, and an inverter, which receives a predetermined constant voltage, generates a PWM signal to drive the backlight, and controls a frequency of the PWM signal based on a decision result of the NTSC/PAL detector.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is an exploded perspective view showing an example of a liquid crystal device (LCD);

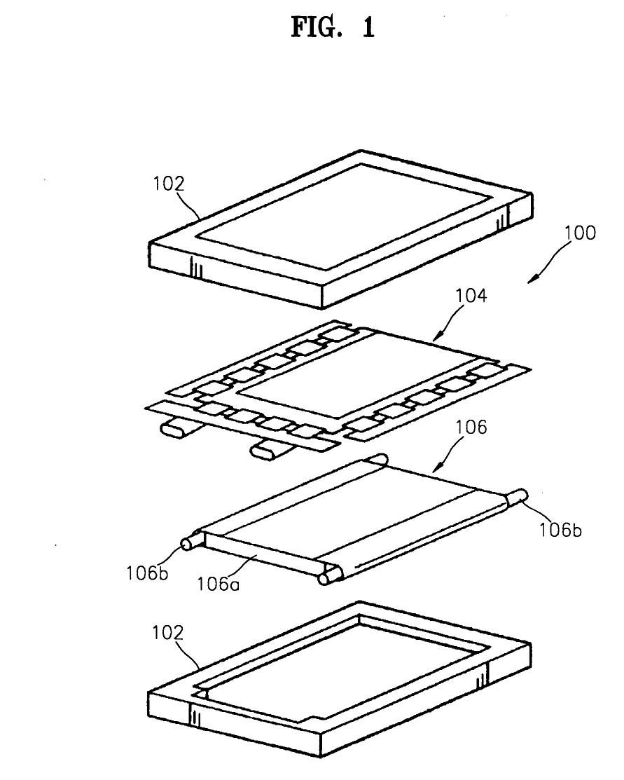

FIG. 2 is a block diagram of a conventional LCD;

FIG. 3 is a block diagram of an LCD according to an embodiment of the present invention; and

FIG. 4 is a flow chart illustrating operations of the LCD shown in FIG. 3.

### DETAILED DESCRIPTION OF THE PREFERRED EMBODIMENT

Reference will now be made in detail to the embodiment of the present invention, examples of which are illustrated in the accompanying drawings, wherein like reference numerals refer to the like elements throughout. The embodiment is described below to explain the present invention by referring to the figures.

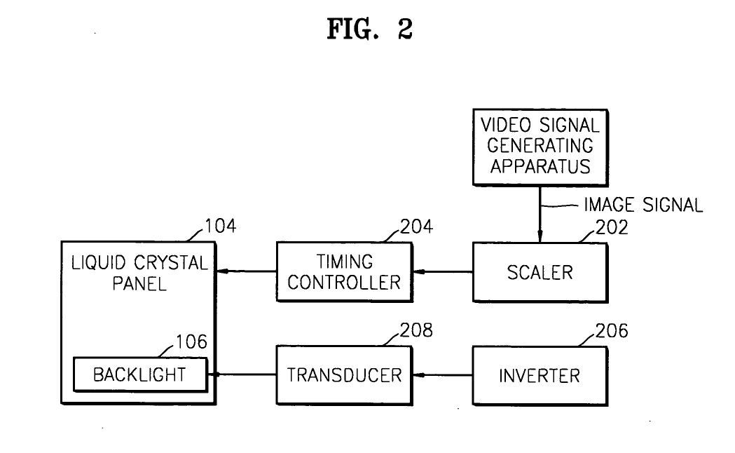

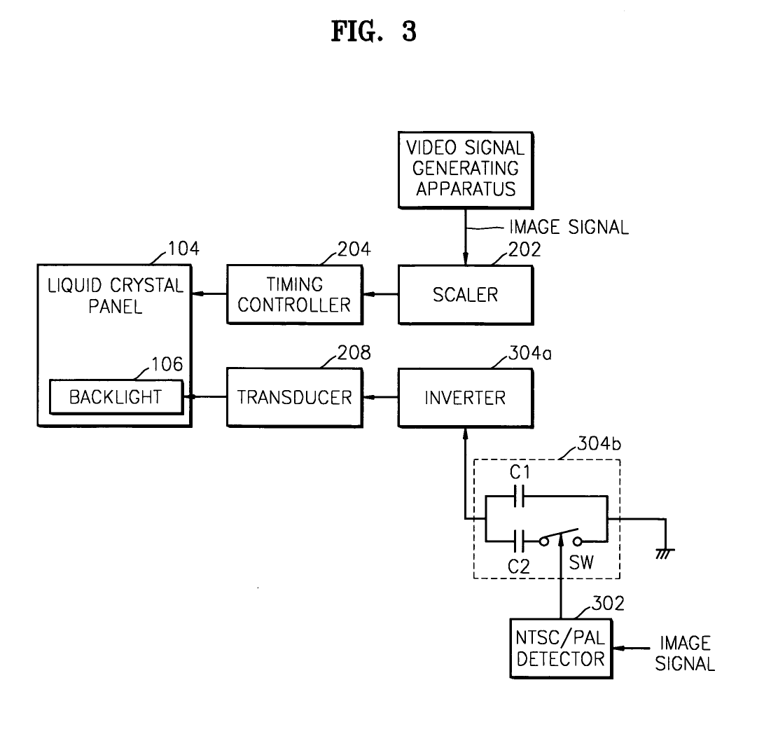

FIG. 3 is a block diagram of an LCD according to an embodiment of the present invention. The same reference numerals in FIGS. 2 and 3 represent the same elements, and a detailed description thereof will be omitted.

Compared with the LCD shown in FIG. 2, the LCD shown in FIG. 3 further comprises an NTSC/PAL detector 302 and a frequency setter 304b. An inverter 304a sets a frequency of an output PWM signal in response to a frequency control signal supplied from the frequency setter 304b.

The NTSC/PAL detector 302 detects whether a picture signal input to the LCD is an NTSC signal or a PAL signal. Since an NTSC picture signal differs from a PAL signal in both a vertical frequency and a number of scan lines (i.e., 60 Hz for a NTSC system and 50 Hz for a PAL system, and 525 lines for the NTSC system and 425 lines for the PAL system), the standard of a picture signal (i.e., the NTSC or PAL standard) is detectable by detecting the vertical frequency and/or the number of scan lines.

The frequency setter 304b comprises first and second capacitors C1 and C2, switchably connectable, in parallel, and a switch SW, which determines whether or not the capacitor C2 is connected. The switch SW is controlled by the NTSC/PAL detector 302. For example, if the picture signal is detected as the NTSC signal, the switch SW is opened. Conversely, if the picture signal is detected as the PAL signal, the switch SW is closed. The entire capacitance of the frequency setter 304b varies according to an operating state of the switch SW. Thus, a frequency of a PWM signal generated from the inverter 304a is varied.

For example, when a picture signal having the size of 720×480 is displayed, a frequency of a PWM signal is 60 Hz×480 Hz in a case of the NTSC picture signal and the frequency of the PWM signal is 50 Hz×480 Hz in a case of the PAL picture signal.

As is described above, the frequency of the PWM signal to drive the backlight 106 converts into a frequency corresponding to the standard to which an input picture signal belongs, thereby preventing an occurrence of noise.

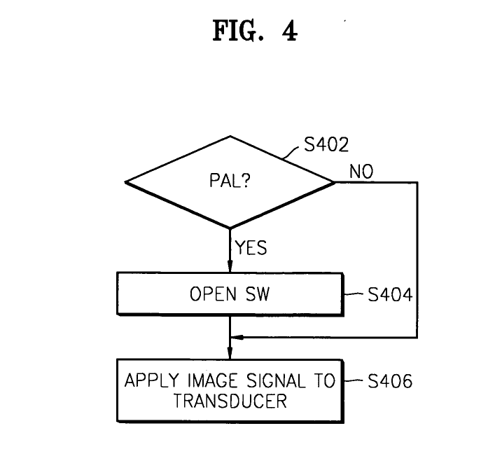

FIG. 4 is a flow chart illustrating operations of the LCD shown in FIG. 3. The LCD shown in FIG. 3 is initialized in the NTSC standard, and it is supposed that a switch SW is closed.

Whether or not a picture signal input to the LCD is in the PAL standard is detected (at operation 402).

If the picture signal is detected, as a PAL signal, the switch SW is opened (at operation 404). Once the switch SW is opened, an entire capacitance of the frequency setter 304b is varied and a frequency of a PWM signal output from the inverter 304a converts into a frequency corresponding to the PAL standard.

In operation 404, if the picture signal is detected as an NTSC signal, the switch SW is not opened. Thus, as initialized, the PWM signal with a frequency that is suitable for the NTSC standard is output from the inverter 304a.

The PWM signal output from the inverter 304a is applied to the transducer 208 and drives the backlight 106.

Although the LCD includes the NTSC/PAL detector in the present embodiment, the NTSC/PAL detector may be replaced by a unit detecting a vertical frequency of a picture signal. Also, the frequency setter 304b controls the inverter 304a such that a proper PWM signal is output based on a detection result of the unit detecting the vertical frequency of the picture signal.

A backlight driving apparatus converts a frequency of a PWM signal supplied from an inverter into a frequency corresponding to a standard to which a picture signal supplied to an LCD belongs, thus effectively preventing an occurrence of noise.

Although an embodiment of the present invention has been shown and described, it would be appreciated by those skilled in the art that changes may be made in the embodiment without departing from the principles and spirit of the invention, the scope of which is defined in the claims and their equivalents.

What is claimed is:

1. A backlight driving apparatus for a liquid crystal device having a liquid crystal panel displaying an output picture signal and a backlight projecting rays on the liquid crystal panel, comprising:
an NTSC/PAL detector, which detects a vertical frequency of an input picture signal; and
an inverter, which receives a predetermined constant voltage and generates a PWM signal to drive the backlight,
wherein the inverter controls a frequency of the PWM signal based on a decision result of the NTSC/PAL detector.

2. The apparatus of claim 1, wherein the NTSC/PAL detector detects whether the input picture signal applied to the liquid crystal device is an NTSC signal or a PAL signal.

3. The apparatus of claim 1, further comprising:
a frequency setter comprising:
two capacitors, which are switchably connectable to each other, in parallel; and
a switch to connect the two capacitors based on the decision result of the NTSC/PAL detector,
wherein the frequency of the pulse width modulation signal is proportional to a value obtained by multiplying a vertical frequency of the input picture signal by a number of vertical lines displayed on the liquid crystal panel.

4. The apparatus of claim 1, further comprising:
a frequency setter comprising:
a first capacitor; and
a series of a second capacitor and a switch, the series of the second capacitor and of the switch and the first capacitor being in parallel, the switch operating based on the decision result of the NTSC/PAL detector,
wherein the frequency of the pulse width modulation signal is proportional to a value obtained by multiplying a vertical frequency of the input picture signal by a number of vertical lines displayed on the liquid crystal panel.

5. An apparatus to drive a backlight for a liquid crystal device to display an output picture signal thereon, comprising:
an NTSC/PAL detector to detect a vertical frequency of an input picture signal; and
an inverter to generate a pulse width modulated signal to drive the backlight and to control a frequency of the pulse width modulated signal based on a decision result of the NTSC/PAL detector.

6. The apparatus of claim 5, wherein the NTSC/PAL detector detects whether the input picture signal applied to the liquid crystal device is an NTSC signal or a PAL signal.

7. The apparatus of claim 5, further comprising:
a frequency setter comprising:
a first capacitor; and
a series of a second capacitor and a switch, the series of the second capacitor and of the switch and the first capacitor being in parallel, the switch operating based on the decision result of the NTSC/PAL detector,
wherein the frequency of the pulse width modulation signal is proportional to a value obtained by multiplying a vertical frequency of the input picture signal by a number of vertical lines displayed on the liquid crystal device.

8. The apparatus of claim 5, further comprising:
a frequency setter comprising:
a switch operating based on the decision result of the NTSC/PAL detector; and
a variable capacitance selectively controlled by the switch such that the frequency of the pulse width modulation signal is proportional to a vertical frequency of the input picture signal.

9. The apparatus of claim 6, wherein the NTSC/PAL detector is initialized to one of the NTSC signal and the PAL signal.

10. An apparatus to drive a backlight for a liquid crystal device to display an output picture signal thereon, comprising:
a detector to detect a vertical frequency of an input picture signal; and
an inverter to generate a signal to drive the backlight and to control a frequency of the signal according to the detected vertical frequency of the input picture signal.

11. The apparatus of claim 9, wherein the detector detects whether the input picture signal applied to the liquid crystal device is an NTSC signal or a PAL signal.

12. An apparatus to drive a backlight for a liquid crystal device to display an output picture signal thereon, comprising:
an NTSC/PAL detector to detect a number of vertical lines displayed on the liquid crystal device; and
an inverter to generate a pulse width modulated signal to drive the backlight and to control a frequency of the pulse width modulated signal based on a decision result of the NTSC/PAL detector.

13. An apparatus to drive a backlight for a liquid crystal device to display an output picture signal thereon, comprising:
a detector to detect a vertical frequency of an input picture signal and/or a number of vertical lines displayed on the liquid crystal device;
an inverter to generate a pulse width modulation signal to drive the backlight; and
a frequency setter to set a frequency of the pulse width modulation signal generated from the inverter according to a detected result of the detector.

14. The apparatus of claim 13, wherein the frequency setter comprises:
a switch such that a capacitance of the frequency setter varies according to an operating state of the switch.

15. A method of driving a backlight for a liquid crystal device to display an output picture signal thereon, comprising:
detecting a vertical frequency of an input picture signal;
generating a pulse width modulated signal to drive the backlight; and
controlling a frequency of the pulse width modulated signal based on the detecting.

16. The method of claim 15, wherein the detecting of the vertical frequency comprises:
detecting whether the input picture signal applied to the liquid crystal device is an NTSC signal or a PAL signal.

17. The method of claim 15, wherein the controlling of the frequency of the pulse width modulated signal comprises:
changing the frequency of the pulse width modulation signal proportional to a value obtained by multiplying a vertical frequency of the input picture signal by a number of vertical lines displayed on the liquid crystal device.

18. The method of claim 15, wherein the controlling of the frequency of the pulse width modulated signal comprises:
operating a switch based on a result of the detecting; and
selectively controlling the frequency of the pulse width modulation signal to be proportional to a vertical frequency of the input picture signal according to the operating.

19. The method of claim 15, wherein the controlling of the frequency of the pulse width modulated signal comprises:
initializing the frequency of the pulse width modulation signal to one of an NTSC input picture signal and a PAL input picture signal.

20. A method of driving a backlight for a liquid crystal device to display an output picture signal thereon, comprising:
detecting a number of vertical lines displayed on the liquid crystal device;
generating a pulse width modulated signal to drive the backlight; and
controlling a frequency of the pulse width modulated signal based on the detecting.

21. A method of driving a backlight for a liquid crystal device to display an output picture signal thereon, comprising:
detecting whether a picture signal input to the liquid crystal device is in a video standard;
converting a frequency of a pulse width modulated signal output from an inverter into a frequency corresponding to the video standard; and
driving the backlight using the frequency corresponding to the video standard.

22. The method of claim 21, further comprising:
initializing the frequency of the pulse width modulation signal to one of an NTSC video standard and a PAL video standard.

23. An apparatus to drive a backlight for a liquid crystal device to display an output picture signal thereon, comprising:
a detector to detect one or more attributes of a video standard of an input picture signal; and
an inverter to generate a pulse width modulated signal to drive the backlight such that a frequency of the pulse width modulated signal is based on a decision result of the detector.

24. The apparatus of claim 23, further comprising:
a frequency setter comprising:
a switch operating based on the decision result of the detector; and
a variable capacitance selectively controlled by the switch such that the frequency of the pulse width modulation signal is proportional to a vertical frequency of the input picture signal.
